(19) United States
(12) Patent Application Publication
(10) Pub. No.: US 2017/0057201 A1
(43) Pub. Date: Mar. 2, 2017

(54) COMPOSITE COMPONENT

(71) Applicant: ROLLS-ROYCE plc, London (GB)

(72) Inventors: Beene M'MEMBE, Bristol (GB); James K. LANDER, Bristol (GB); Robert C. BACKHOUSE, Wells (GB); Stephen R. HALLETT, Bristol (GB); Mehdi YASAEE, Bristol (GB); Ivana K. PARTRIDGE, Bristol (GB)

(73) Assignee: ROLLS-ROYCE plc, London (GB)

(21) Appl. No.: 15/222,011

(22) Filed: Jul. 28, 2016

(30) Foreign Application Priority Data
Aug. 25, 2015 (GB) 1515045.1

(51) Int. Cl. B32B 7/08; F04D 29/32; F04D 29/38; F04D 29/52

(52) U.S. Cl. CPC B32B 7/08; F04D 29/522; F04D 29/325; F04D 29/38; F05B 2220/302; F05B 2280/10; F05B 2280/6003; F05B 2280/6013; F05B 2280/6015

(57) ABSTRACT

A composite component comprises a plurality of plies and a plurality of pins extending in a direction transverse to the plies. The pins comprise a first region formed from a first material and a second region formed from a second material.

### TECHNICAL FIELD

The present disclosure concerns a composite component, a fan blade, a casing and/or a gas turbine engine.

### BACKGROUND

Gas turbine engines are typically employed to power aircraft. Typically a gas turbine engine will comprise an axial fan driven by an engine core. The engine core is generally made up of one or more turbines which drive respective compressors via coaxial shafts. The fan is usually driven off an additional lower pressure turbine in the engine core.

The fan comprises an array of radially extending fan blades mounted on a rotor. The fan blades and/or a casing that surrounds the fan may be manufactured from metallic and/or composite (e.g. non-metallic) materials. In composite fan blades, the blades may include a composite body and a metallic leading edge and a metallic trailing edge.

Composite components are often laminate structures that include a plurality of plies. Each ply generally includes reinforcing fibres (e.g. high strength or high stiffness fibres) embedded in a matrix, e.g. a plastic matrix material. The matrix material of adjacent stacked plies is bonded together to build the composite component. The matrix material is weaker than the fibre material and as such the bond between stacked plies can form a point of weakness. This means that a primary failure mechanism of concern for composite materials is delamination.

Delamination for example of a fan blade may occur in the event of an impact by a foreign object such as a bird strike.

To reduce the risk of delamination of a composite component through thickness reinforcement can be used. One type of through thickness reinforcement is pinning (which may be referred to as z-pinning). A component that has been pinned includes a plurality of pins (or rods) extending through the thickness of the component in a direction transverse to the general direction of the plies.

Pins are generally made of a metallic or composite material and typically have a diameter ranging from or equal to approximately 0.2 mm to 1 mm. Often, composite pins are manufactured by pultrusion of a carbon fibre tow impregnated by a thermoset resin. The pins of a composite component exert a bridging force on the plies to hold the plies in position relative to each other, this reduces opening of inter-laminar cracks (known as mode I failure) and sliding displacements of inter-laminar cracks (known as mode II failure).

When a fan blade is impacted, e.g. by a bird strike, the fan blade will experience mode I and mode II loading. As such, the pins need to be able to resist delamination in both mode I and mode II.

### SUMMARY OF DISCLOSURE

In a first aspect there is provided a composite component comprising a plurality of plies, and a plurality of pins extending in a direction transverse to the plies. The pins comprise a first region formed from a first material and a second region formed from a second material.

The first material is different from the second material.

In the present application the reference to a region refers to a region at a single location, i.e. in the present application a region cannot be independently split across multiple locations.

All of the first material of the pin may be contained within the first region.

The first region may be manufacturable independently of the second region.

The first material may be a composite material. For example, the first material may comprise carbon fibres in a resin matrix.

The second material may be a metallic material. For example, the second material may be steel, e.g. stainless steel.

The second region may be at least partially (e.g. fully) encased by the first region.

The second region may form a core of the pin.

The second region may be concentric with the first region.

The second region may occupy at least 10% of the overall volume of the pin.

The pins may comprise further regions. The further regions may be surrounded by the first region. The further regions may comprise the same material as the second region or may comprise a different material to the second region. The pins may be elongate and one or more of the second or further regions may extend along the elongate axis of the pin.

The pin may comprise two or more different regions that are intertwined together. For example, the pin may comprise a spiral of the two or more different regions.

The component may be a fan blade or a casing for a gas turbine engine.

In a second aspect there is provided a gas turbine engine comprising the component according to any one of the previous claims.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a sectional side view of a gas turbine engine;

FIG. 2 is a perspective view of a fan blade;

FIG. 3 is a cross sectional schematic view of a laminate that is reinforced with pins and may define part of the blade of FIG. 2;

FIG. 4 is a perspective view of a pin used to reinforce the laminate of FIG. 3;

FIG. 5 is a perspective view of a test piece used to measure the performance of the pin of FIG. 4 in mode I and mode II failure modes;

FIG. 6 is an end view of an alternative pin; and

FIG. 7 is a side view of a further alternative pin.

### DETAILED DESCRIPTION

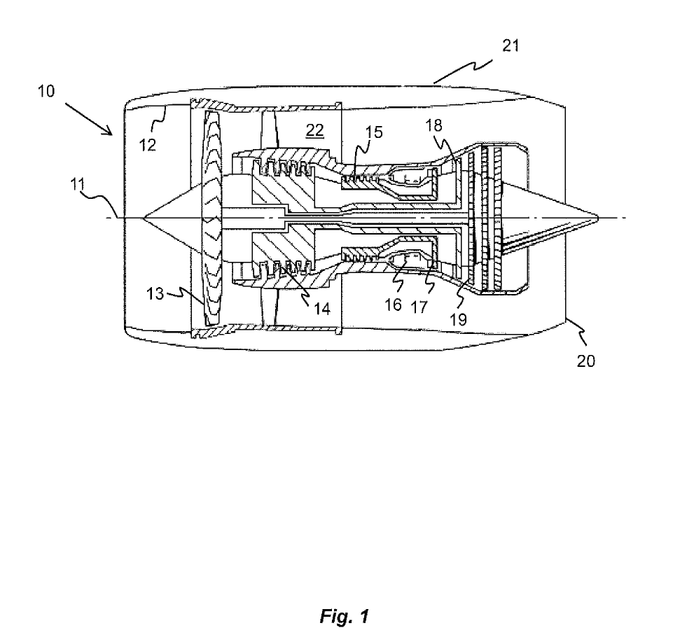

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The intake fan 12 comprises an array of radially extending fan blades 40 that are mounted to the shaft 26. The shaft 26 may be considered a hub at the position where the fan blades 40 are mounted. The fan blades are surrounded by a fan casing 39, which may be made from a composite material.

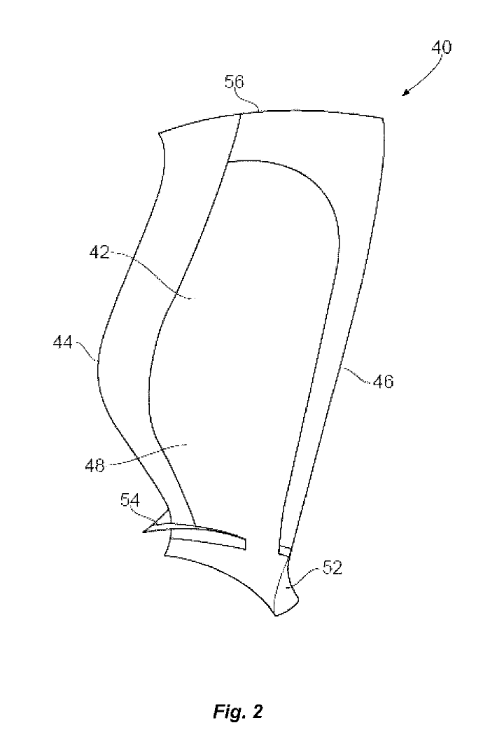

Referring to FIG. 2, the fan blades 40 each comprise an aerofoil portion 42 having a leading edge 44, a trailing edge 46, a concave pressure surface wall 48 extending from the leading edge to the trailing edge and a convex suction surface wall extending from the leading edge to the trailing edge. The fan blade has a root 52 via which the blade can be connected to the hub. The fan blade has a tip 56 at an opposing end to the root. The fan blade may also have an integral platform 54 which may be hollow or ribbed for out of plane bending stiffness. The fan blade includes a metallic leading edge and a metallic trailing edge. The remainder of the blade (e.g. the body of the blade) is made from composite material.

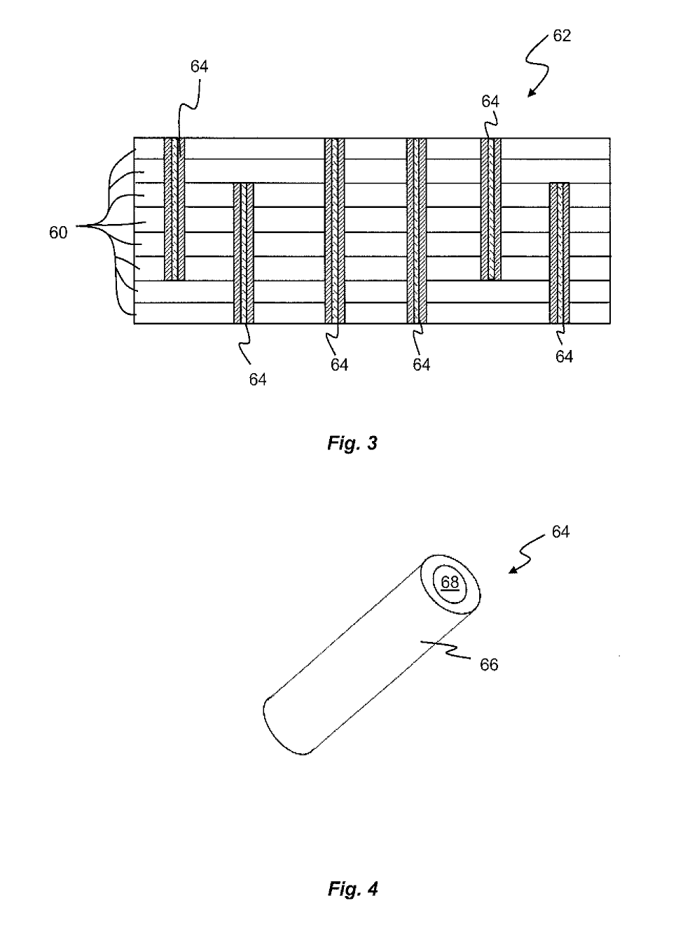

Referring to FIG. 3, the composite material includes a laminate 60 having a plurality of plies 62 reinforced by pins 64. The pins 64 extend through the thickness of the laminate and are transverse to the plies. In the present example the pins are arranged substantially perpendicular to the plies, but in alternative embodiments the pins may be angled by a different angle, e.g. 45° to the plies. The pins may be arranged to extend through the full thickness of a component or through the partial thickness of a component, and/or a component may have pins extending from one surface of the component or from opposing surfaces of the component.

Referring now to FIG. 4, the pin includes a first region 66 formed from a first material and a second region 68 formed from a second material. In the present example, the first material is a carbon fibre composite material that has carbon fibres embedded within a resin matrix. The second material is a metallic material, for example stainless steel.

The first region 66 is a hollow cylinder. The second region 68 is cylindrical and arranged to be substantially concentric to the hollow cylinder. In the present example, the hollow cylinder is formed separately to the cylindrical second region. The hollow cylinder and the cylindrical region are dimensioned to be a close fit.

In the present example the hollow cylinder of the first region 66 has an external diameter of approximately 700 μm and an internal diameter of approximately 400 μm, and the external diameter of the cylinder of the second region is approximately 300 μm-400 μm. However, in alternative embodiments any suitable diameter may be used for example the external diameter of the pin may be less than or equal to 1 mm and the ratio of the volume of the first region to the volume of the second region can be varied.

To manufacture the pin 64, a metallic wire is positioned in the bore of a hollow composite rod. The pins 64 may be inserted into the laminate 62 of the composite component using an ultrasonic hammer or using the method described in U.S. Pat. No. 8,893,367 which is incorporated herein by reference. The method of U.S. Pat. No. 8,893,367 can exert a lower force on the pin during insertion, which can reduce the risk of buckling and therefore provide more flexibility in the design of the pin.

When the pin 64 is used to reinforce a laminate, the first region 66 which is made from a composite material provides good interfacial interaction with the laminate. This means that at lower load mixities, where frictional forces between the laminate and pins dominate the failure mechanisms of a composite component, the pin 64 will maintain good apparent fracture toughness.

Apparent fracture toughness is understood in the art, and refers to the fracture toughness of the component or specimen when pinned; generally fracture toughness is considered to be a material property, when pins are added to a laminate they change the structure not the material properties, so the fracture toughness is referred to as the apparent fracture toughness.

The second region which is made from a metallic material results in high apparent fracture toughness at high mode mixities where shear failure is dominant.

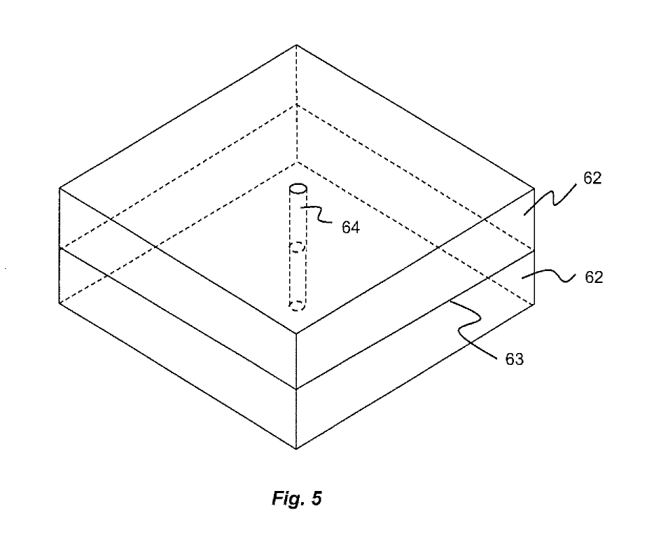

The performance of the pin 64 was tested using the test specimen illustrated in FIG. 5. The performance of the pin 64 was compared to a fully carbon composite pin and to a fully metallic pin. The test specimen includes two plies 62 and a release film 63 between the two plies to represent a crack. The specimen was tested at different mode mixities at a load rate of 0.5 mm/min until failure.

The fully carbon composite pins were found to have relatively high apparent fracture toughness at mode mixities below 0.37 where frictional pull-out of the pins is the dominant failure mode. However, above this, when there is high shear loading on the pins the pins rupture and their bridging effectiveness is significantly reduced. The measure of mode mixity is a scale from 0 to 1, such that 0 is failure that is entirely mode I, and 1 is failure that is entirely mode II.

The fully metallic pins were found to have high apparent fracture toughness at higher mode mixities, above approximately 0.6, where the shear loading is dominant. However, at lower mode mixities, the metallic pins had lower apparent fracture toughness than the fully carbon pins.

The pin 64 when tested was an improvement over both the fully carbon composite pin and the fully metallic pin. At a mode mixity of 0 the hybrid pin 64 performed substantially as well as the fully carbon pin, and at a mode mixity of 1 the hybrid pin 64 performed substantially as well as the fully metallic pin. In a mode mixity between 0 and 1, when the general trend is plotted (using test data at various mode mixities) the hybrid pin 64 has a greater apparent fracture toughness than the metallic pin and the carbon composite pin for the majority of mode mixities.

As has been demonstrated, the pin 64 can perform better across a variety of mode mixities than a conventional single material pin. To the best of the inventor's knowledge at the time of filing, there are no hybrid pins in the prior art. The materials chosen for the pin 64, the percentage of each material, and the shape and structure of the first and second regions (and further regions if applicable) can be selected to tailor the pin to resist the failure mechanisms expected for a given component.

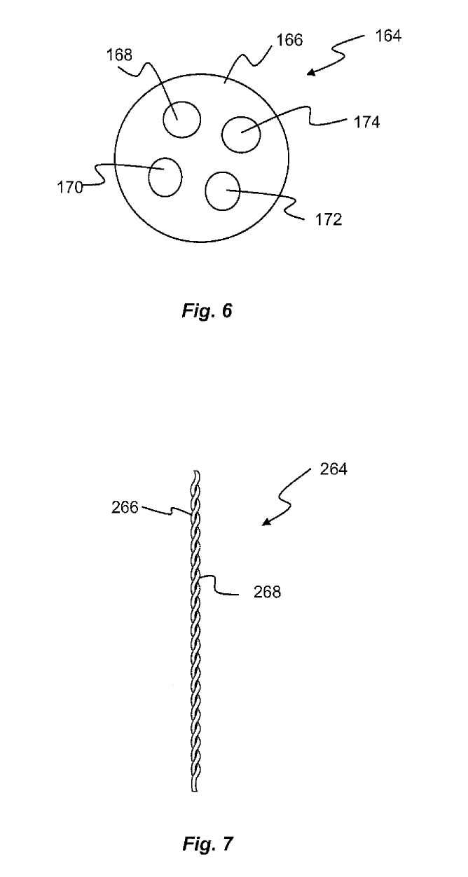

Referring now to FIG. 6 an alternative pin 164 is shown. Similar reference numerals are used as those used in FIG. 4, but with a prefix 1.

The pin 164 includes a first region 166 that fully surrounds a second region 168. In addition to the second region, a third region 170, fourth region 172 and fifth region 174 are provided. The regions 170, 172 and 174 are distinct regions and are all individually surrounded by the first region 166. The second, third, fourth and fifth regions are cylindrical. The first region makes up the remainder of the pin and defines an outer circumferential surface of the pin. In the present example, the second, third, fourth and fifth regions are made from the same material, e.g. metal. The first region is made from carbon fibre composite material (e.g. carbon fibre embedded in a resin matrix).

Referring now to FIG. 7, an example of a further alternative pin 264 is shown. Similar reference numerals are used as for the pin of FIG. 4 but with a prefix “2”.

The pin 264 has a first region 266 and a second region 268. The first region and the second region are made from cylindrical wires that are intertwined. The first region may be formed from a carbon fibre composite material and the second region may be formed from a metallic material. The carbon fibre composite material may be provided in an uncured or partially cured state, the two regions may be intertwined, and after the two wires are intertwined the carbon fibre composite may be fully cured.

In further alternative embodiments, the pin may have a metallic core and the composite material may be interleaved or braided around the metallic core.

The pin has been described as being cylindrical in shape or being of a twisted shape, but in alternative embodiments the pin may have any suitable shape. The shape of the first region and the second region can differ from that described and/or the proportion of the first region to the second region can differ. The shape and/or proportion may be selected so as to optimise the pin performance required for a given component.

The materials used for the pin may be varied so as to achieve optimal properties for a given application. Further, the embodiments described include two different materials, but in alternative embodiments the pin may include more than two types of material. The additional materials may be selected to provide the required properties for a given component. In one example, the pin may include a carbon composite, a metallic material, and glass. In a further example, the composite material may include Kevlar fibres. At least one of the materials that forms an outer circumferential surface of the pin should have good interfacial properties with the laminate material (i.e. with the material of the plies of the composite component). The materials used in second, or further regions should be compatible with the resin system of the material used in the first region. In alternative examples, a third material may be provided between for example the first region and the second region, the third material being selected to improve bonding between the first region and the second region.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A composite component comprising:
a plurality of plies; and
a plurality of pins extending in a direction transverse to the plies;
wherein the pins comprise a first region formed from a first material and a second region formed from a second material.

2. The component according to claim 1, wherein the first material is a composite material.

3. The component according to claim 2, wherein the first material comprises carbon fibres in a resin matrix.

4. The component according to claim 1, wherein the second material is a metallic material.

5. The component according to claim 4, wherein the second material is steel.

6. The component according to claim 1, wherein the second region is at least partially encased by the first region.

7. The component according to claim 1, wherein the second region forms a core of the pin.

8. The component according to claim 1, wherein the second region is concentric with the first region.

9. The component according to claim 1, wherein the second region occupies at least 10% of the overall volume of the pin.

10. The component according to claim 1, wherein the component is a fan blade or a casing for a gas turbine engine.

11. A gas turbine engine comprising the component according to claim 1.

12. A composite component comprising:
a plurality of plies; and
a plurality of pins extending in a direction transverse to the plies;
wherein the pins comprise a first region formed from a first material and a second region formed from a second material, wherein the first material is a composite material and wherein the second material is a metallic material.

13. The component according to claim 12, wherein the second region is at least partially encased by the first region.

14. The component according to claim 12, wherein the second region forms a core of the pin.

15. The component according to claim 12, wherein the second region is concentric with the first region.

16. The component according to claim 12, wherein the second region occupies at least 10% of the overall volume of the pin.

17. The component according to claim 12, wherein the component is a fan blade or a casing for a gas turbine engine.

18. A gas turbine engine comprising the component according to claim 12.
